(19) United States
(12) Patent Application Publication
(10) Pub. No.: US 2005/0191960 A1
(43) Pub. Date: Sep. 1, 2005

(54) Car stereo hard disk player

(75) Inventor: Stephen Chen, Shengang Shiang (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd.

(21) Appl. No.: 10/748,293

(22) Filed: Dec. 31, 2003

(51) Int. Cl. H04H 7/00

(52) U.S. Cl. 455/3.06

(57) ABSTRACT

A car stereo hard disk player and particularly a player coupling with a car stereo to broadcast digital music (such as MP3) includes a case, a hard disk drive, a music control unit and a radio emission unit. The invention enables users to store a great amount of music through computers or the like to a portable hard disk drive for broadcasting in the car to save the trouble and risk of changing music CD during driving.

### BACKGROUND OF THE INVENTION

1. Field of the Invention

The invention relates to a car stereo hard disk player and particularly to a player coupling with a car stereo to broadcast digital music (such as MP3) to enable users to broadcast a large amount of music in cars that are stored in portable hard disk drives through computers and the like without the trouble and risk of changing music CDs during driving.

2. Description of the Prior Art

At present digital music broadcasting can only be performed on dedicated digital players such as personal computer or MP3, but cannot be played in cars. Car stereo is limited to radio broadcast, CD or cassette tape. The CD and cassette tape have a larger size and are difficult to carry. Moreover, the general car stereo has only one tape slot and the CD cartridge can hold only one dozen of CDs or less. They are not as convenient as the digital music.

### SUMMARY OF THE INVENTION

In view of the aforesaid disadvantages, the object of the invention is to provide a car stereo hard disk player for playing digital music in cars through a portable hard disk which contains a great amount of music through computers and the like to save the trouble and risk of changing music CD during driving and coupling with radio remote control for music selection to improve convenience and safety.

In order to achieve the foregoing object the car stereo hard disk player according to the invention includes a case for receiving a hard disk drive that is installed on a selected location in a car (according to user's requirements and available space in the car), a hard disk drive which has a shell containing a hard disk to store digital music data and a socket (such as USB, ISO1394, RS232, etc.) on the shell to couple with computer I/O to connect to the case and a computer, a music control unit for reading digital music data stored in the hard disk drive for broadcasting, and a radio emission unit for modulating the digital music broadcast by the music control unit to radio signals so that users can receive and broadcast through the FM function of the stereo. By means of the construction set forth above, users can store a great amount of music in a portable hard disk drive and play in the car.

The music control unit includes a hard disk flat cable connected to the hard disk drive for transmitting data, a hard disk interface chip for reading the data stored in the hard disk, and a digital music decoding unit for transforming the digital music data read from the hard disk to music signals for broadcasting.

The radio emission unit is a modulating emission or AM circuit for modulating the digital music broadcast by the music control unit to radio signals so that users can use the FM function of the car stereo to receive and broadcast.

The car stereo hard disk player according to the invention may also include a display screen and an operation button key set for displaying user selection and broadcast data.

The car stereo hard disk player according to the invention may further include a radio remote controller to enable users to select music in a remote fashion to enhance operation convenience and safety.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the embodiment of the invention.

FIG. 2 is a block diagram of the invention.

FIG. 3 is a schematic view of a first embodiment of the invention.

FIG. 4 is a schematic view of a second embodiment of the invention.

### DESCRIPTION OF THE PREFERRED EMBODIMENTS

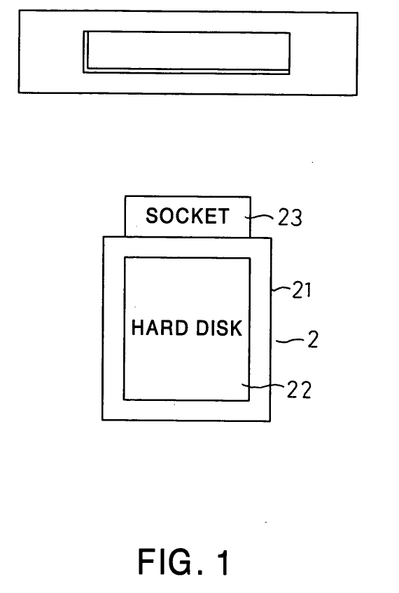

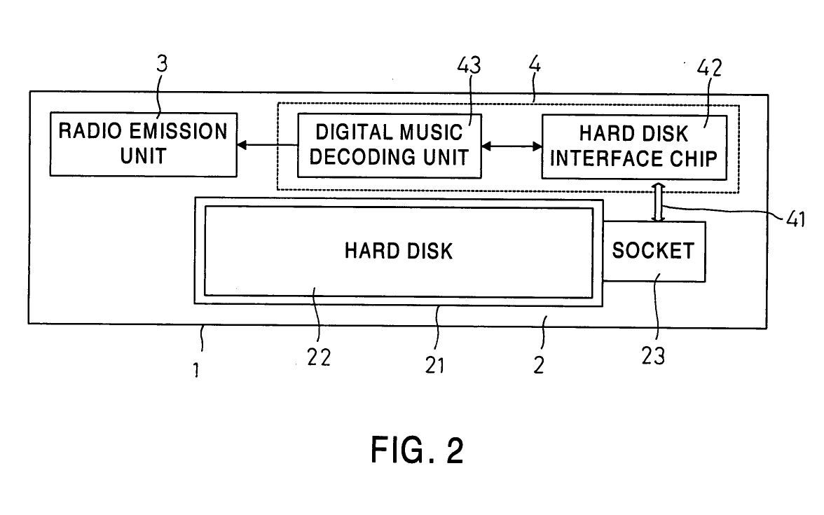

Referring to FIGS. 1 and 2, the car stereo hard disk player according to the invention includes:
a case 1 for receiving a hard disk drive 2 that is installed on a selected location in a car;
a hard disk drive 2 which has a shell 21 containing a hard disk 22 to store digital music data. The shell 21 has a socket 23 (such as USB, ISO1394, RS232, etc.) to couple with computer I/O to connect to the case 1 or a computer;
a music control unit 4 for reading the digital music data stored in the hard disk drive 2 for broadcasting. The music control unit 4 includes a hard disk flat cable 41 for connecting to the hard disk drive 2 to transmit data, a hard disk interface chip 42 for reading the data stored in the hard disk 22, and a digital music decoding unit 43 for transforming the digital music data read from the hard disk 22 to music signals for broadcasting; and
a radio emission unit 3 which is a modulating emission or AM circuit for modulating the digital music broadcast by the music control unit 4 to radio signals so that users can use the FM function of the car stereo 5 to receive and broadcast.

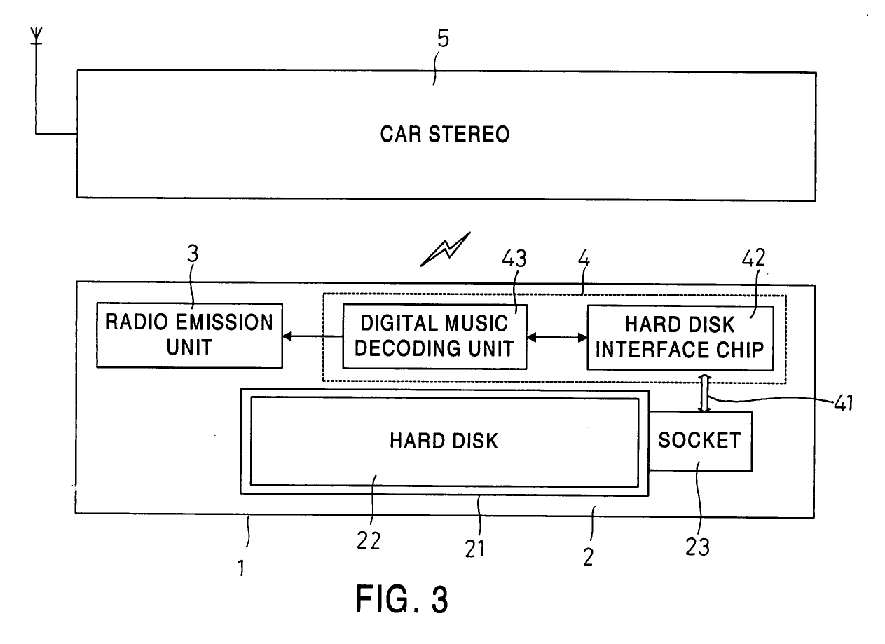

Referring to FIG. 3, by means of the construction set forth above users can retrieve the hard disk drive 2 freely as desired to connect to a computer or the like. After the data on the hard disk 22 in the hard disk drive 2 have been changed, the hard disk drive 2 may be placed back in the case 1 so that the hard disk interface chip 42 of the music control unit 4 can read the data on the hard disk. The hard disk flat cable 41 transmits the data to allow the digital music decoding unit 43 to decode and transform to music signals and output to the radio emission unit 3. The music signals are modulated to radio signals of a specific frequency to enable users to receive and broadcast through the FM (broadcast) function of the car stereo 5. Thereby users can store a great amount of music in the portable hard disk drive 2 and play in the car. It also saves the trouble and risk of replacing or disposing music CDs during driving.

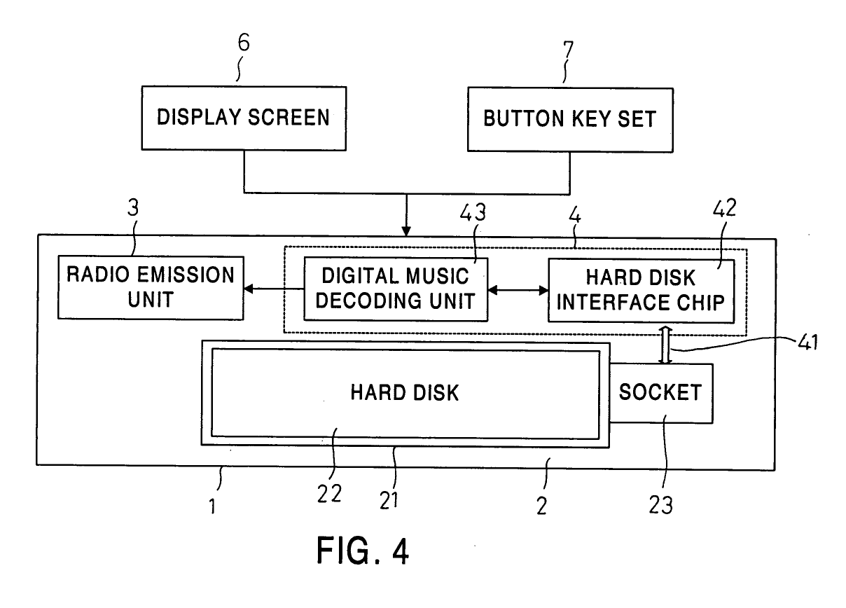

Referring to FIG. 4, the invention may also include a display screen 6 and an operation button key set 7 for displaying user selection and broadcast data.

Finally, the invention may further include a radio remote controller to enable users to select music in a remote fashion thereby to enhance operation convenience and safety.

By means of the construction and embodiments set forth above, the invention enables users to transfer and store a great amount of music data and carry to the car to connect to the car stereo for broadcasting, thereby overcome the limitation and inconvenience of selecting and playing music in the car occurred to conventional approaches.

1. A car stereo hard disk player, comprising:
a case for receiving hard disk drives installed on a selected location;
a hard disk drive for storing digital music data;
a music control unit for reading the digital music data stored in the hard disk drive and broadcasting; and
a radio emission unit for modulating the digital music broadcast by the music control unit to radio signals to be received and broadcast through FM function of a car stereo.

2. The car stereo hard disk player of claim 1, wherein the music control unit includes:
a hard disk flat cable for connecting to the hard disk drive to transmit data;
a hard disk interface chip for reading the data stored in the hard disk; and
a digital music decoding unit for transforming the digital music data read from the hard disk to music signals for broadcasting.

3. The car stereo hard disk player of claim 1, wherein the radio emission unit is a modulating emission circuit for modulating the digital music broadcast by the music control unit to radio signals to be received and broadcast through a FM function of the car stereo.

4. The car stereo hard disk player of claim 1, wherein the radio emission unit is an AM emission circuit for modulating the digital music broadcast by the music control unit to radio signals to be received and broadcast through a modulating function of the car stereo.

5. The car stereo hard disk player of claim 1 further having a display screen and an operation button key set for displaying user selection and broadcast data.

6. The car stereo hard disk player of claim 1 further having a radio remote controller to facilitate music selection.

7. The car stereo hard disk player of claim 1, wherein the hard disk drive includes a shell and a socket to couple with computer I/O.
